(19) United States
(12) Patent Application Publication
(10) Pub. No.: US 2007/0044606 A1
(43) Pub. Date: Mar. 1, 2007

(54) System and method for cutting liquid crystal display substrate

(75) Inventors: Ho-min Kang, Suwon-si (KR); Weon-woo Choi, Yongin-si (KR); Seung-lyong Bok, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/510,020

(22) Filed: Aug. 24, 2006

(30) Foreign Application Priority Data
Aug. 25, 2005 (KR) 10-2005-0078345

(51) Int. Cl. B26D 1/00

(52) U.S. Cl. 83/13

(57) ABSTRACT

A cutting system and method for a liquid crystal display (LCD) substrate in which a first cutting unit cuts the LCD substrate in one direction into a plurality of sub-substrates each including at least one panel, a carrier unit separates the sub-substrates from each other and simultaneously carries the separated sub-substrates to a second cutting unit that cuts the separated sub-substrates into individual LCDs.

### REFERENCE TO RELATED APPLICATION

This application claims priority from Korean Patent Application No. 10-2005-0078345 filed on Aug. 25, 2005 in the Korean Intellectual Property Office, the disclosure of which is incorporated herein by reference in its entirety.

### FIELD OF THE INVENTION

The present invention relates to a system for cutting a liquid crystal display (LCD) substrate, and more particularly, to a faster cutting system

### DESCRIPTION OF THE RELATED ART

An LCD displays image information by using the electrical and optical characteristics of liquid crystals injected between two sheets of material. LCDs consume less power and are lighter and smaller than cathode ray tubes. Accordingly, LCDs are widely used in a display of portable computers, monitors of desktop computers, and monitors for high-definition video system, etc. Manufacturing LCDs includes forming a first display plate and a second display plate each having at least one unit panel, a process of bonding the first and second display plates to each other to form an LCD substrate, a process of cutting the LCD substrate into unit panels, and a process of injecting liquid crystals into the unit panels. The cutting process includes first scribing a preliminary cutting line in a first direction on one side of an LCD substrate, i.e., using a wheel having greater hardness than glass; a first breaking step applying a force to the preliminary cutting line formed on the first display plate; a second scribing step in which the LCD substrate is reversed and a preliminary cutting line is scribed on the second display plate; and a second breaking step applying a force to the preliminary cutting line formed on the second display plate.

The first and second breaking steps are performed in a first cutting system and a second cutting system, respectively. After the first breaking step, the LCD substrate is divided into sub-substrates including at least one unit panel. Thereafter, the sub-substrates are carried to the second cutting system and then divided into unit panels. In a conventional second cutting system, only a single sub-substrate is cut at one time to prevent cross cutting, and therefore, the cutting process takes a long time. Various cutting methods including one disclosed in Korea Patent Publication No. 2003-086727, entitled “Scribe/Break System for Cutting LCD Substrate” have been proposed, but the above-described problem has not be solved. Therefore, development of an LCD substrate cutting system and method for reduction of the cutting time is desired.

### SUMMARY OF THE INVENTION

The present invention provides a faster cutting system for a liquid crystal display (LCD) substrate in which a first cutting unit cuts the LCD substrate in one direction into a plurality of sub-substrates each including at least one panel, a carrier unit separates the sub-substrates from each other and simultaneously carries the separated sub-substrates.

### BRIEF DESCRIPTION OF THE DRAWING

The above and other features and advantages of the present invention will become more apparent from a reading of the following description together with the drawing, in which:

FIGS. 1A and 1B are side views of a cutting system for an LCD substrate according to a first embodiment of the present invention;

FIG. 2 is a front view of a first mount and a first cutting portion shown in FIG. A;

FIG. 3 is a front view of a second mount and a second cutting portion shown in FIG. 1B;

FIG. 4 is a front view of the first mount and a carrier unit shown in FIG. 1A;

FIGS. 5A through 5H illustrate stages in a cutting process performed by the cutting system according to the first embodiment of the present invention; and

FIG. 6 is a side view of a cutting system for an LCD substrate according to a second embodiment of the present invention.

### DETAILED DESCRIPTION

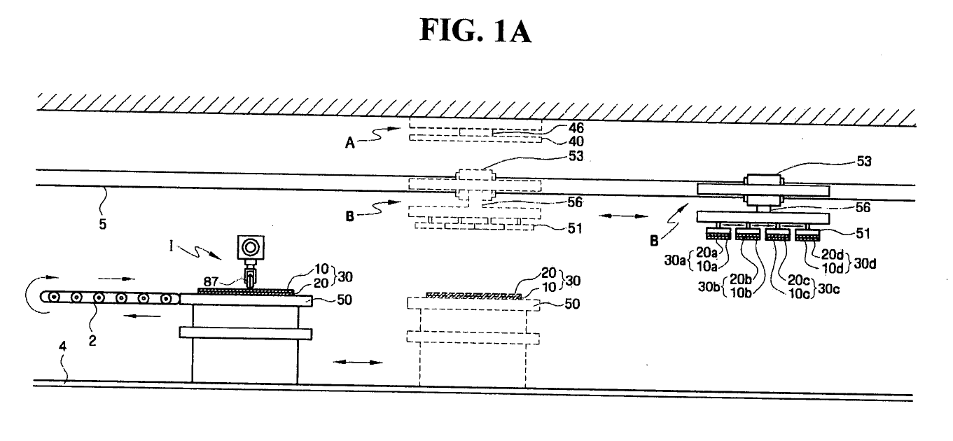

Referring to FIGS. 1A through 3, the cutting system includes a first cutting unit which cuts an LCD substrate 30 in a first direction into a plurality of sub-substrates 30a, 30b, 30c, and 30d; a second cutting unit which simultaneously cuts the sub-substrates 30a, 30b, 30c, and 30d in a second direction into a plurality of unit panels; and a carrier unit B which sucks and carries the sub-substrates 30a, 30b, 30c, and 30d from the first cutting unit to the second cutting unit. Here, the first direction is one direction between a longitudinal direction and a transverse direction and the second direction is perpendicular to the first direction. Hereinafter, it is assumed that the first direction is the longitudinal direction and the second direction is the transverse direction. The first cutting unit includes a first mount 50, a first suction portion ‘A’, and a first cutting portion ‘I’.

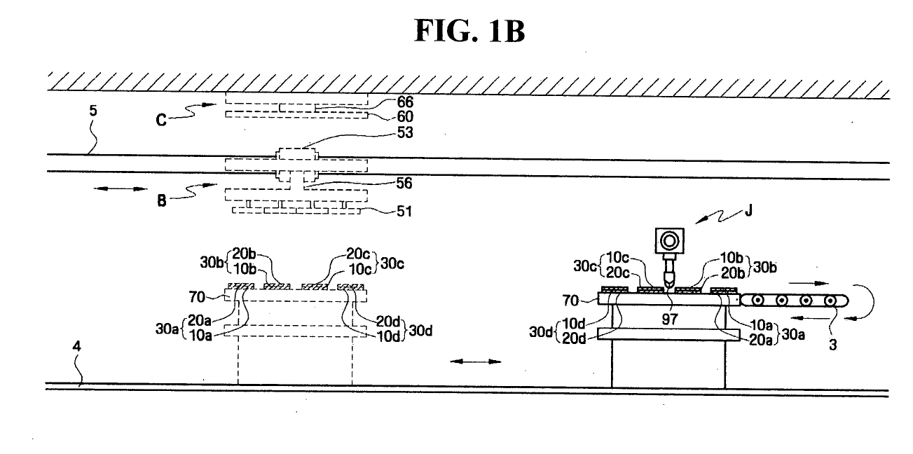

The LCD substrate 30 (hereinafter, referred to as the substrate 30), in which a first display plate 10 and a second display plate 20 are bonded to each other, is mounted onto the first mount 50. The first mount 50 slides back and forth along lower rails 4 included in the cutting system so that the first mount 50 allows the substrate 30 to be cut in the longitudinal direction in association with the first cutting portion ‘I’ The first mount 50 may be connected with a first carrier 2 and fed with the substrate 30 by the first carrier 2. The first carrier 2 may be implemented by a plurality of rollers or a conveyer belt and may be driven by electrical or magnetic power, but the present invention is not restricted thereto. The first cutting portion ‘I cuts the substrate 30 into the plurality of the sub-substrates 30a, 30b, 30c, and 30d each including one or more panels. For this cutting operation, the first cutting portion ‘I’, as shown in FIG. 2, includes supports 81 formed at both sides of the first mount 50, a central axle 82 connected between the upper ends of the respective supports 81, and at least one wheel 87 made using a material such as diamond having a higher hardness than the substrate 30 and provided at the central axle 82.

Here, the wheel 87 moves along the central axle 82 and cuts one side of the substrate 30 mounted on the first mount 50 in the longitudinal direction. The substrate 30 placed on the first mount 50 can be cut in the longitudinal direction through the relative movements of the first cutting portion ‘I’ and the first mount 50. For example, the first mount 50 may move along the lower rails 4 while the first cutting portion ‘I’ is fixed to cut the substrate 30 in the longitudinal direction. In detail, after one side of the substrate 30 is cut by the wheel 87 moving along the central axle 82, the first mount 50 proceeds along the lower rails 4 by the width of a sub-substrate. Thereafter, when the wheel 87 moves along the central axle 82, the one side of the substrate 30 is continuously cut in the width of the sub-substrate.

The above-described procedure is repeated so that the substrate 30 is cut in the longitudinal direction. In another example, the first cutting portion ‘I’ may be moved while the first mount 50 is fixed to cut the substrate 30 in the longitudinal direction. In still another example, both of the first mount 50 and the first cutting portion ‘I’ may be moved simultaneously to cut the substrate 30 in the longitudinal direction. Hereinafter, it is assumed that the first mount 50 moves while the first cutting portion ‘I’ is fixed to cut the substrate 30 in the longitudinal direction. As described above, the first cutting portion ‘I’ cuts in the longitudinal direction the one side of the substrate 30 and the other side of the substrate 30 reversed by the carrier unit B, which will be described later, through the relative movement with the first mount 50. As a result, the first cutting unit forms the sub-substrates 30a, 30b, 30c, and 30d including one or more panels.

The first suction portion ‘A’ sucks the reversed substrate 30 from the carrier unit B and places the substrate 30 back to the first mount 50. For this operation, the first suction portion ‘A’ includes a first cutting unit suction plate 40 sucking the reversed substrate 30 and a first cutting unit cylinder 46 lifting up and down the first cutting unit suction plate 40. The first suction portion ‘A’ may be fixed at a predetermined position on an upper side within the cutting system or may be moved back and forth along a rail provided at an upper portion of the cutting system.

Carrier unit B sucks and reverses the substrate 30 whose one side has been cut in the longitudinal direction by the first cutting portion ‘I’. In addition, the carrier unit B sucks and separates the sub-substrates 30a, 30b, 30c, and 30d by a predetermined distance and then carries them to the second cutting unit. For these operations, the carrier unit B includes one or more carrier unit suction plates 51 including a plurality of suction holes, a driving portion (not shown) separating the carrier unit suction plates 51, a carrier unit cylinder 56 lifting the carrier unit suction plates 51 in a vertical direction with respect to the ground, a carrier unit suction (not shown) sucking air through the suction holes of the carrier unit suction plates 51 so that the substrate 30 on the first mount 50 is attached to the carrier unit suction plates 51, and a rotator 53 rotating the carrier unit suction plates 51 so that the substrate 30 is reversed.

It is preferable that the carrier unit suction plates 51 respectively suck the plurality of the sub-substrates 30a, 30b, 30c, and 30d formed by the first cutting portion ‘I’. In addition, carrier unit suction plates 51 may have diverse shapes and sizes to suck the sub-substrates 30a, 30b, 30c, and 30d. For example, the carrier unit suction plates 51 may have substantially the same shapes as the sub-substrates 30a, 30b, 30c, and 30d. In detail, the sub-substrates 30a, 30b, 30c, and 30d may have a bar shape with a long axis and a short axis, and the carrier unit suction plates 51 may have a shape corresponding to the shape of the sub-substrate 30a. Alternatively, the carrier unit suction plates 51 may have the same size as the size of at least one between the long and short axis of the sub-substrate 30a. For example, when the carrier unit suction plates 51 have a bar shape with a long axis and a short axis, the long axis of the carrier unit suction plates 51 may be the same length as or a longer or shorter length than the long axis of the sub-substrate 30a. However, the present invention is not restricted thereto, and the carrier unit suction plates 51 may have any shape allowing the carrier unit suction plates 51 to suck and hold the sub-substrates 30a, 30b, 30c, and 30d.

The driving portion (not shown) forms a predetermined distance between the carrier unit suction plates 51 so that the sub-substrates 30a, 30b, 30c, and 30d sucked by the carrier unit suction plates 51 are separated from each other by a predetermined distance, for example, 10 mm or more. As a result, when the plurality of the sub-substrates 30a, 30b, 30c, and 30d are simultaneously cut in the transverse direction by the second cutting unit, failures caused by cross cutting are prevented. The driving portion may be implemented by a means capable of generating a horizontal motion so that a predetermined distance is formed between the carrier unit suction plates 51. For example, the driving portion may be implemented by an actuator such as an electric motor or a hydraulic cylinder. However, the present invention is not restricted thereto.

In addition, the rotator 53 rotates the carrier unit suction plates 51 so that the substrate 30 is reversed. The rotator 53 may be implemented by a means capable of generating a rotary motion, for example, an actuator such as an electric motor or a hydraulic motor, but the present invention is not restricted thereto. In addition, the rotator 53 is combined with a guide rail 5 provided at a side wall of the cutting system through a slider to move back and forth. As a result, the carrier unit B moves back and forth along the guide rail 5.

Next, the second cutting unit includes a second mount 70 on which the sub-substrates 30a, 30b, 30c, and 30d are placed; a second suction portion C sucking and holding the sub-substrates 30a, 30b, 30c, and 30d reversed by the carrier unit B; and a second cutting portion ‘J’ cutting each of the sub-substrates 30a, 30b, 30c, and 30d into unit panels.

The sub-substrates 30a, 30b, 30c, and 30d carried by the carrier unit B are placed on the second mount 70. Here, the sub-substrates 30a, 30b, 30c, and 30d are separated from each other by a predetermined distance, for example, 10 mm or more. The second mount 70 may be moved back and forth along the lower rails 4 provided within the cutting system. As a result, the second mount 70 allows the sub-substrates 30a, 30b, 30c, and 30d to be cut in the transverse direction in association with the second cutting portion ‘J’.

In addition, the second mount 70 may be connected with a second carrier 3. The second carrier 3 carries the unit panels to a system for succeeding processes, for example, a system for bonding a polarizing plate to a panel. The second carrier 3 may be implemented by a plurality of rollers or a conveyer belt and may be driven by electrical or magnetic power, but the present invention is not restricted thereto.

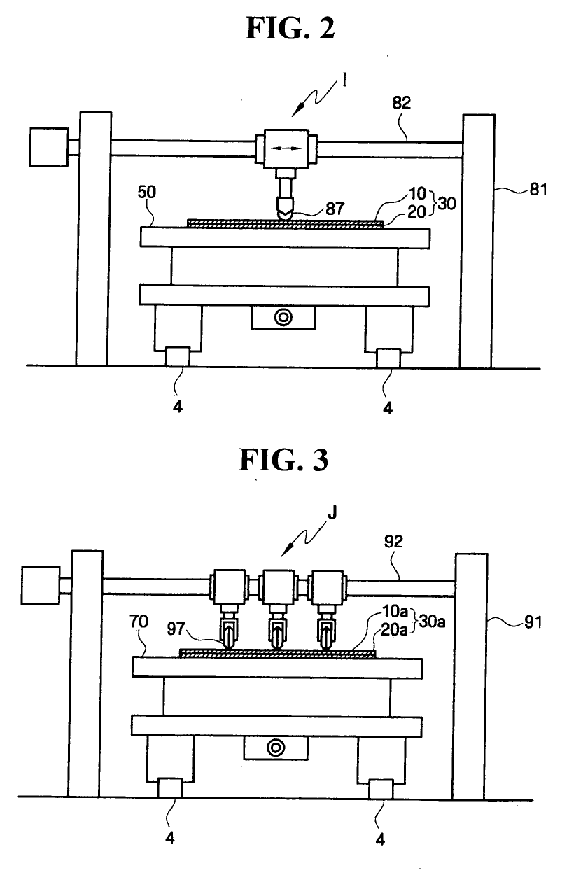

The second cutting portion ‘J’ cuts the sub-substrates 30a, 30b, 30c, and 30d on the second mount 70 into unit panels. For this operation, the second cutting portion ‘J’, as shown in FIG. 3, includes supports 91 formed at both sides of the second mount 70, a central axle 92 connected between the upper ends of the respective supports 91, and one or more wheels 97 made using a material such as diamond having a higher hardness than the sub-substrates 30a, 30b, 30c, and 30d and provided at the central axle 92. The parallel spacing between the wheels 97 may be adjusted according to the size of the unit panels.

The sub-substrates 30a, 30b, 30c, and 30d placed on the second mount 70 can be cut in the transverse direction through the relative movements of the second cutting portion ‘J’ and the second mount 70. For example, the second mount 70 may move along the lower rails 4 while the second cutting portion ‘J’ is fixed to cut the sub-substrates 30a, 30b, 30c, and 30d in the transverse direction. In another example, the second cutting portion ‘J’ may be moved while the second mount 70 is fixed to cut the sub-substrates 30a, 30b, 30c, and 30d in the transverse direction. In still another example, both of the second mount 70 and the second cutting portion ‘J’ may be moved simultaneously to cut the sub-substrates 30a, 30b, 30c, and 30d in the transverse direction. Hereinafter, it is assumed that the second mount 70 moves while the second cutting portion ‘J’ is fixed to cut the sub-substrates 30a, 30b, 30c, and 30d in the transverse direction.

As described above, the second cutting portion ‘J’ cuts in the transverse direction the one side of the sub-substrates 30a, 30b, 30c, and 30d and the other side of the sub-substrates 30a, 30b, 30c, and 30d reversed by the carrier unit B through the relative movement with the second mount 70. As a result, the second cutting unit forms panels from the sub-substrates 30a, 30b, 30c, and 30d.

The second suction portion ‘C’ sucks the reversed sub-substrates 30a, 30b, 30c, and 30d from the carrier unit B and places them back to the second mount 70. For this operation, the second suction portion ‘C’ includes a second cutting unit suction plate 60 sucking the reversed sub-substrates 30a, 30b, 30c, and 30d and a second cutting unit cylinder 66 lifting up and down the second cutting unit suction plate 60. The second suction portion ‘C’ may be fixed at a predetermined position on the upper side within the cutting system or may be moved back and forth along a rail 115 (not shown) provided at the upper portion of the cutting system.

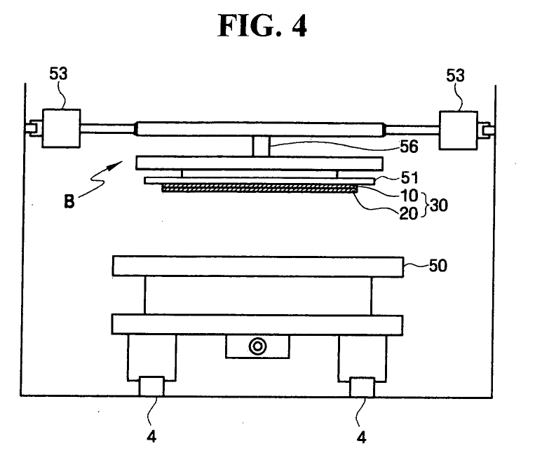

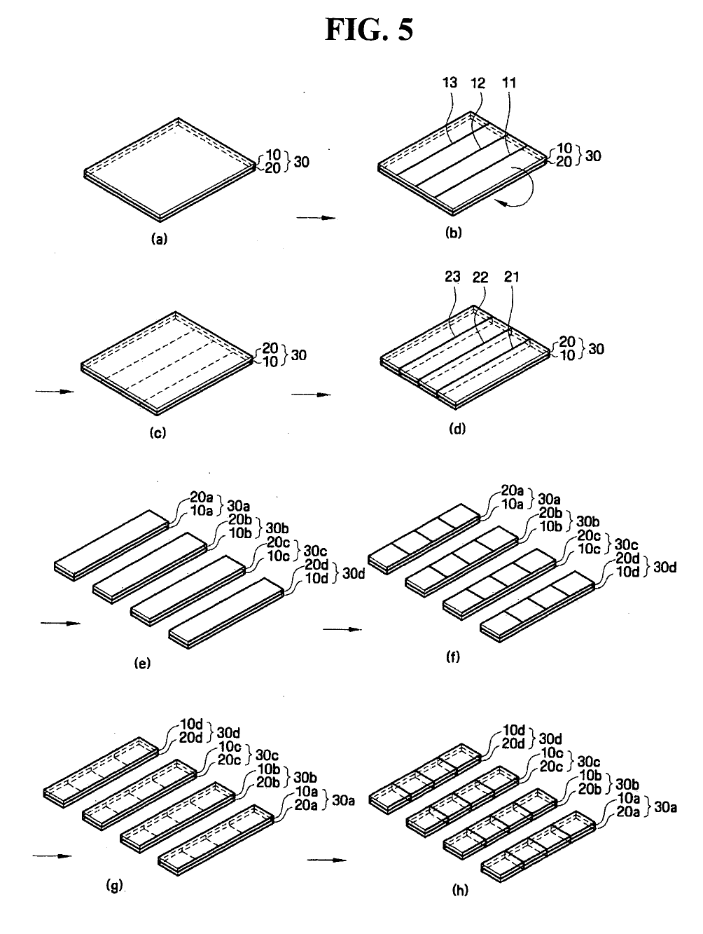

The method of cutting the substrate 30 using the cutting system having the above-described structure will be described with reference to FIGS. 1A through 5H. FIGS. 5A through 5H illustrate stages in a cutting process performed by the cutting system according to the first embodiment of the present invention. The substrate 30 carried by the first carrier 2 is placed onto the first mount 50 in a shape shown in FIG. 5A. After the substrate 30 is placed onto the first mount 50, the first mount 50 moves toward the first cutting portion ‘I’. Thereafter, one side 10 of the substrate 30 on the first mount 50 is cut in the longitudinal direction by the first cutting portion ‘I’, as shown in FIG. 5B. In detail, the wheel 87 of the first cutting portion ‘I’ moves along the central axle 82 so that the one side 10 of the substrate 30 is cut forming a cutting line 11 in FIG. 5B. Then, the first mount 50 proceeds by a width of a sub-substrate. Thereafter, the wheel 87 moves along the central axle 82 so that the one side 10 of the substrate 30 is continuously cut in the width of the sub-substrate forming a cutting line 12 in FIG. 5B. This procedure is repeated forming a cutting line 13 in FIG. 5B. As a result, the one side 10 of the substrate 30 can be cut in the longitudinal direction.

After the one side 10 of the substrate 30 is cut in the longitudinal direction, the first mount 50 moves toward the carrier unit B facing the first suction portion ‘A’.

When the first mount 50, the carrier unit B, and the first suction portion ‘A’ are disposed on one vertical line, the carrier unit suction plates 51 are lifted down to the first mount 50 by the carrier unit cylinder 56. Thereafter, the one side 10 of the substrate 30 placed on the first mount 50 is sucked by the carrier unit suction plates 51. The carrier unit suction plates 51 sucking and holding the substrate 30 are lifted up to a predetermined height by the carrier unit cylinder 56 and then rotated by 180 degrees by the rotator 53. As a result, the substrate 30 sucked and held by the carrier unit suction plates 51 is reversed. After the substrate 30 is reversed, the first cutting unit suction plate 40 is lifted down to the reversed substrate 30 by the first cutting unit cylinder 46. Thereafter, the other side 20 of the substrate 30 is sucked by the first cutting unit suction plate 40.

Next, the carrier unit suction plates 51 are separated from the substrate 30 and the carrier unit B moves forward by a predetermined distance so that the first cutting unit suction plate 40 can be lifted down to the first mount 50.

Next, the first cutting unit suction plate 40 is lifted down to the first mount 50 by the first cutting unit cylinder 46 and the substrate 30 is separated from the first cutting unit suction plate 40 and placed on the first mount 50.

As a result, the substrate 30 is reversed on the first mount 50, as shown in FIG. 5C. Then, the first mount 50 moves backward so that the other side 20 of the substrate 30 can be cut by the first cutting portion ‘I’.

When the first mount 50 is moved to the first cutting portion ‘I’, the other side 20 of the substrate 30 on the first mount 50 is cut in the longitudinal direction by the first cutting portion ‘I’, as shown in FIG. 5D. In more detail, the wheel 87 of the first cutting portion ‘I’ moves along the central axle 82 so that the other side 20 of the substrate 30 is cut in the width of a sub-substrate forming a cutting line 22 in FIG. 5D. Then, the first mount 50 proceeds by the width of the sub-substrate. Thereafter, the wheel 87 moves along the central axle 82 so that the other side 20 of the substrate 30 is continuously cut in the width of the sub-substrate forming a cutting line 22 in FIG. 5D. This procedure is repeated forming a cutting line 23 in FIG. 5D. As a result, the substrate 30 is divided into the sub-substrates 30a, 30b, 30c, and 30d including one or more panels, as shown in FIG. 5E.

After the sub-substrates 30a, 30b, 30c, and 30d are formed by the first cutting unit using the above-described method, the first mount 50 moves forward to face the carrier unit B. When the first mount 50 faces the carrier unit B, the carrier unit suction plates 51 are lifted down to the first mount 50 to suck the sub-substrates 30a, 30b, 30c, and 30d on the first mount 50.

When one sides 20a, 20b, 20c, and 20d of the respective sub-substrates 30a, 30b, 30c, and 30d are sucked and held by the carrier unit suction plates 51, the carrier unit suction plates 51 are lifted up by the carrier unit cylinder 56. Here, it is preferable that the carrier unit suction plates 51 suck the sub-substrates 30a, 30b, 30c, and 30d, respectively. Then, the carrier unit suction plates 51 are separated by a predetermined distance from each other by the driving portion (not shown) of the carrier unit B. As a result, the sub-substrates 30a, 30b, 30c, and 30d sucked and held by the carrier unit suction plates 51 are separated from each other by a predetermined distance. Here, the predetermined distance between the sub-substrates 30a, 30b, 30c, and 30d may be determined such that failures due to cross cutting can be prevented when the sub-substrates 30a, 30b, 30c, and 30d are cut in the transverse direction by the second cutting portion ‘J’. For example, the sub-substrates 30a, 30b, 30c, and 30d may be separated by a distance of 10 mm or more.

After the sub-substrates 30a, 30b, 30c, and 30d are separated from each other, the carrier unit B moves forward to the second mount 70. Here, the carrier unit B may move along the guide rail 5 provided at the side wall of the cutting system. When the carrier unit suction plates 51 face the second mount 70, the carrier unit suction plates 51 are lifted down to the second mount 70 to place the sub-substrates 30a, 30b, 30c, and 30d onto the second mount 70. When the carrier unit suction plates 51 are separated from the sub-substrates 30a, 30b, 30c, and 30d, the sub-substrates 30a, 30b, 30c, and 30d are placed on the second mount 70 separated from each other by the predetermined distance.

After the sub-substrates 30a, 30b, 30c, and 30d are placed onto the second mount 70, the second mount 70 moves forward to the second cutting portion ‘J’. Thereafter, the other sides 20a, 20b, 20c, and 20d of the respective sub-substrates 30a, 30b, 30c, and 30d on the second mount 70 are cut in the transverse direction, as shown in FIG. 5F. After the other sides 20a, 20b, 20c, and 20d of the respective sub-substrates 30a, 30b, 30c, and 30d are cut in the transverse direction using the above-described method, the second mount 70 moves backward to face the carrier unit B.

When the second mount 70 faces the carrier unit B, the carrier unit suction plates 51 are lifted down to the second mount 70 to suck the sub-substrates 30a, 30b, 30c, and 30d.

When the other sides 20a, 20b, 20c, and 20d of the respective sub-substrates 30a, 30b, 30c, and 30d are sucked and held by the carrier unit suction plates 51, the carrier unit suction plates 51 is lifted up to a predetermined height by the carrier unit cylinder 56 and then rotated by 180 degrees by the rotator 53 to face the second cutting unit suction plate 60. As a result, the sub-substrates 30a, 30b, 30c, and 30d sucked and held by the carrier unit suction plates 51 are reversed.

The second cutting unit suction plate 60 is lifted down to the carrier unit suction plates 51 to suck the reversed sub-substrates 30a, 30b, 30c, and 30d. One sides 10a, 10b, 10c, and 10d of the respective sub-substrates 30a, 30b, 30c, and 30d are sucked and held by the second cutting unit suction plate 60. The carrier unit suction plates 51 are separated from the sub-substrates 30a, 30b, 30c, and 30d and the carrier unit B moves backward so that the second cutting unit suction plate 60 can be lifted down to the second mount 70.

After the carrier unit B moves backward, the second cutting unit suction plate 60 is lifted down to the second mount 70 by the second cutting unit cylinder 66. Then, the sub-substrates 30a, 30b, 30c, and 30d are separated from the second cutting unit suction plate 60 and placed onto the second mount 70, as shown in FIG. 5G. After the sub-substrates 30a, 30b, 30c, and 30d are placed on the second mount 70, the second mount 70 moves forward to the second cutting portion ‘J’. Thereafter, the one sides 10a, 10b, 10c, and 10d of the respective sub-substrates 30a, 30b, 30c, and 30d on the second mount 70 are simultaneously cut in the transverse direction by the second cutting portion ‘J’. As a result, the sub-substrates 30a, 30b, 30c, and 30d are divided into unit panels, as shown in FIG. 5H. These panels are carried to a system for succeeding processes, for example, a system for bonding a polarizing plate to a panel, by the second carrier 3 connected to the second mount 70.

As described above, when the cutting system and the cutting method using the cutting system according to the first embodiment of the present invention are used, a plurality of sub-substrates can be simultaneously cut in the second cutting unit, so that time taken for a cutting process can be reduced. In addition, when the sub-substrates 30a, 30b, 30c, and 30d are placed onto the second mount 70, they are separated from each other by a predetermined distance. Accordingly, when the plurality of the sub-substrates 30a, 30b, 30c, and 30d are simultaneously cut in the transverse direction, failures due to cross cutting can be prevented.

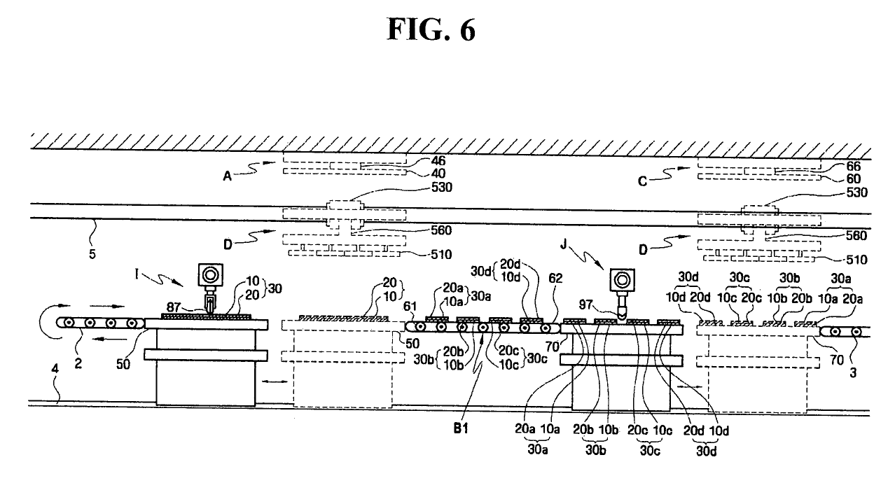

Hereinafter, a cutting system and method for an LCD substrate according to a second embodiment of the present invention will be described with reference to FIG. 6. FIG. 6 is a side view of a cutting system for an LCD substrate according to the second embodiment of the present invention. For clarity of the description, like elements in the drawing are denoted by like reference numerals and detailed descriptions thereof will be omitted.

Referring to FIG. 6, the cutting system according to the second embodiment of the present invention fundamentally has the same structure as the cutting system according to the first embodiment of the present invention, with the following exceptions. A carrier unit B1 is disposed on the same horizontal line as the first mount 50 and the second mount 70. The carrier unit B1 may be implemented by a conveyer belt. When the carrier unit B1 is implemented by the conveyer belt, the carrier unit B1 may include a roller 61 and a driving portion (not shown) rotating the roller 61.

The roller may be rotated by electrical or magnetic power. More than one roller 61 may be provided to efficiently feed the sub-substrates 30a, 30b, 30c, and 30d to the second mount 7. In addition, the carrier unit B1 may further include a belt 62 surrounding the rollers 61. The belt 62 moves in a predetermined direction when the rollers 61 rotates, so that the sub-substrates 30a, 30b, 30c, and 30d placed on the belt 62 are fed to the second mount 70.

The driving portion (not shown) varies the rotation speed of the rollers 61 to separate the sub-substrates 30a, 30b, 30c, and 30d fed from the first mount 50 from each other by a predetermined distance, so that the separated sub-substrates 30a, 30b, 30c, and 30d are carried to the second mount 70. In detail, before the sub-substrates 30a, 30b, 30c, and 30d are fed from the first mount 50, the driving portion rotates the rollers 61 at a constant speed. Thereafter, when the first sub-substrate 30d is fed from the first mount 50, the driving portion increases the rotation speed of the rollers 61 for a predetermined period of time and then decreases the rotation speed to the original speed. Thereafter, when the second sub-substrate 30c is fed from the first mount 50, the driving portion increases again the rotation speed of the rollers 61 for the predetermined period of time and then decreases it to the original speed. Here, the sub-substrates 30a, 30b, 30c, and 30d are fed from the first mount 50 at a constant speed. Accordingly, when the above-described procedure is repeated, the sub-substrates 30a, 30b, 30c, and 30d fed from the first mount 50 are separated from each other by a predetermined distance. The above-described driving portion may be implemented by a device, for example, an actuator such as an electric or a hydraulic motor, capable of generating a rotary motion, but the present invention is not restricted thereto.

In addition, the cutting system according to the second embodiment of the present invention may include a reversing unit D. The reversing unit D reverses the substrate 30 whose one side has been cut in the longitudinal direction by the first cutting portion ‘I’ and the sub-substrates 30a, 30b, 30c, and 30d whose one sides have been cut in the transverse direction by the second cutting portion ‘J’. For this operation, the reversing unit D includes a reversing unit suction plate 510, a reversing unit cylinder 560, and a reversing unit rotator 530.

The reversing unit cylinder 560 lifts up and down the reversing unit suction plate 510 so that the reversing unit suction plate 510 can suck and hold the substrate 30 and the sub-substrates 30a, 30b, 30c, and 30d. The one side 10 of the substrate 30 placed on the first mount 50 and the sides 20a, 20b, 20c, and 20d of the respective sub-substrates 30a, 30b, 30c, and 30d placed on the second mount 70 are sucked by the reversing unit suction plate 510. For this operation, the reversing unit suction plate 510 may include a plurality of suction holes (not shown).

The reversing unit rotator 530 rotates the reversing unit suction plate 510 sucking and holding the one side 10 of the substrate 30 to reverse the substrate 30. The reversing unit rotator 530 may be implemented by a device, such as an electric motor or a hydraulic cylinder, generating a rotary motion. In addition, the reversing unit rotator 530 is combined with the guide rail 5 through a slider (not shown) so that the reversing unit D can move back and forth along the guide rail.

In a method of cutting the substrate 30 using the cutting system according to the second embodiment of the present invention, the substrate 30 fed through the first carrier 2 is placed onto the first mount 50. Then, the first mount 50 moves to the first cutting portion ‘I’. Thereafter, the one side 10 of the substrate 30 on the first mount 50 is cut in the longitudinal direction using the wheel 87 included in the first cutting portion ‘I’.

Thereafter, the first mount 50 moves to the reversing unit D. When the first mount 50 is positioned to face the reversing unit D, the reversing unit suction plate 510 is lifted down to the first mount 50 by the reversing unit cylinder 560 and sucks and holds the one side 10 of the substrate 30.

Thereafter, the reversing unit suction plate 510 holding the substrate 30 is lifted up to a predetermined height by the reversing unit cylinder 560 and then rotated by 180 degrees by the reversing unit rotator 530 to face the first cutting unit suction plate 40. As a result, the substrate 30 held by the reversing unit suction plate 510 is reversed. After the substrate 30 is reversed, the first cutting unit suction plate 40 is lifted down to the substrate 30 by the first cutting unit cylinder 46 and sucks the other side 20 of the reversed substrate 30. Thereafter, the reversing unit suction plate 510 is separated from the one side 10 of the substrate 30 and the reversing unit D moves forward by a predetermined distance so that the first cutting unit suction plate 40 can be lifted down to the first mount 50.

The first cutting unit suction plate 40 is lifted down to the first mount 50 by the first cutting unit cylinder 46. The substrate 30 is separated from the first cutting unit suction plate 40 and placed on the first mount 50. After the substrate 30 is reversed as described above, the first mount 50 moves backward so that the first cutting portion ‘I’ can cut the other side 20 of the substrate 30. After the first mount 50 reaches the first cutting portion ‘I’, the wheel 87 of the first cutting portion ‘I’ moves along the central axle 82 while the first mount 50 moves along the lower rails 4 step by step, so that the other side 20 of the substrate is cut in the longitudinal direction. As a result, the substrate 30 is divided into the sub-substrates 30a, 30b, 30c, and 30d including one or more panels. After the sub-substrates 30a, 30b, 30c, and 30d are formed through the above-described procedure, the first mount 50 moves forward to the carrier unit B1.

Sub-substrates 30a, 30b, 30c, and 30d on the first mount 50 are sequentially loaded to the carrier unit B1 at a predetermined speed. Here, the driving portion of the carrier unit B1 may vary the rotation speed of the rollers 61 so that the sub-substrates 30a, 30b, 30c, and 30d are separated from each other by a predetermined distance which can prevent failures from occurring due to cross cutting when the sub-substrates 30a, 30b, 30c, and 30d are simultaneously cut in the transverse direction.

In detail, when the first sub-substrate 30d is loaded onto the carrier unit B1, the driving portion increases the rotation speed of the rollers 61 for a predetermined period of time and then decreases it to the original speed.

Thereafter, when the second sub-substrate 30c is loaded onto the carrier unit B1, the driving portion increases again the rotation speed of the rollers 61 for the predetermined period of time and then decreases it to the original speed. By repeating the increase and decrease of the rotation speed, the sub-substrates 30a, 30b, 30c, and 30d are separated from each other by the predetermined distance, for example, 10 mm or more. As a result, the sub-substrates 30a, 30b, 30c, and 30d are fed to the second mount 70 separated from each other by the predetermined distance. When all of the separated sub-substrates 30a, 30b, 30c, and 30d are loaded onto the second mount

70, the second mount 70 moves to the second cutting portion ‘J’. The other sides 20a, 20b, 20c, and 20d of the respective sub-substrates 30a, 30b, 30c, and 30d are simultaneously cut by the second cutting portion ‘J’ in the transverse direction. After the cutting is completed, the second mount 70 moves to face the reversing unit D. After the second mount 70 is positioned facing the reversing unit D, the reversing unit suction plate 510 is lifted down to the second mount 70 by the reversing unit cylinder 560. Then, the other sides 20a, 20b, 20c, and 20d of the respective sub-substrates 30a, 30b, 30c, and 30d is sucked by the reversing unit suction plate 510.

Thereafter, the reversing unit suction plate 510 is lifted up to a predetermined height by the reversing unit cylinder 560 and then rotated by 180 degrees by the reversing unit rotator 530 to face the second cutting unit suction plate 60. As a result, the sub-substrates 30a, 30b, 30c, and 30d sucked and held by the reversing unit suction plate 510 are reversed.

Thereafter, the second cutting unit suction plate 60 is lifted down to the reversed sub-substrates 30a, 30b, 30c, and 30d by the second cutting unit cylinder 66 and sucks the one sides 10a, 10b, 10c, and 10d of the respective sub-substrates 30a, 30b, 30c, and 30d. Next, the reversing unit suction plate 510 is separated from the other sides 20a, 20b, 20c, and 20d of the respective sub-substrates 30a, 30b, 30c, and 30d. The reversing unit D moves backward by a predetermined distance. Then, the second cutting unit suction plate 60 is lifted down to the second mount 70 by the second cutting unit cylinder 66. The sub-substrates 30a, 30b, 30c, and 30d are separated from the second cutting unit suction plate 60 and placed onto the second mount 70. Thereafter, the second mount 70 moves backward to the second cutting portion ‘J’ and then moves along the lower rails 4 step by step so that the second cutting portion ‘J’ cuts the one sides 10a, 10b, 10c, and 10d of the respective sub-substrates 30a, 30b, 30c, and 30d in the transverse direction. As a result, the sub-substrates 30a, 30b, 30c, and 30d are divided into a plurality of unit panels.

In the above-described embodiments, the first cutting portion ‘I’ and the second cutting portion ‘J’ include the wheels 87 and 97 made using a material like diamond having a higher hardness than the substrate 30, but the present invention can also use lasers as the first and cutting portions ‘I’ and ‘J’. In addition, the substrate 30 and the sub-substrates 30a, 30b, 30c, and 30d are reversed in the above-described embodiments, but they may be cut without being reversed in other embodiments.

In addition, it has been described that the substrate 30 is cut in a state where it is parallel to the ground. However, the substrate 30 may be cut in a state where it is almost or clearly perpendicular to the ground. In the above-described embodiments, the substrate 30 is cut using the two cutting units. However, the substrate 30 may be cut into panel units using one cutting unit. As above described, the cutting system and method for the liquid crystal display (LCD) substrate according to the present invention, the cutting system simultaneously cuts a plurality of sub-substrates, thereby reducing cutting time. In addition, since the sub-substrates are separated from each other when they are simultaneously cut, failures due to cross cutting can be prevented.

In concluding the detailed description, those skilled in the art will appreciate that many variations and modifications can be made to the preferred embodiments without substantially departing from the principles of the present invention.

What is claimed is:

1. A cutting system for a liquid crystal display (LCD) substrate, comprising:
a first cutting unit cutting the LCD substrate in one direction into a plurality of sub-substrates each including at least one panel;
a carrier unit separating the sub-substrates from each other and simultaneously carrying the separated sub-substrates; and
a second cutting unit cutting the separated sub-substrates in a second direction into panels.

2. The cutting system of claim 1, wherein the carrier unit comprises:
a plurality of carrier unit suction plates sucking the sub-substrates, respectively; and
a driving portion separating the carrier unit suction plates from each other.

3. The cutting system of claim 2, wherein the driving portion is an electric motor or a hydraulic cylinder.

4. The cutting system of claim 1, wherein the first cutting unit comprises:
a first mount on which the LCD substrate is placed; and
a first cutting portion cutting one side of the LCD substrate on the first mount in the first direction.

5. The cutting system of claim 4, wherein the carrier unit comprises a rotator sucking and rotating the LCD substrate whose one side has been cut to reverse the LCD substrate, and the first cutting unit further comprises a first suction portion sucking and lifting other side of the LCD substrate from the carrier unit and placing the LCD substrate onto the first mount.

6. The cutting system of claim 5, wherein the first cutting portion cuts in the first direction the other side of the LCD substrate that has been reversed by the carrier unit and the first suction portion.

7. The cutting system of claim 4, wherein the first cutting portion comprises at least one among a laser and a wheel having a higher hardness than the LCD substrate.

8. The cutting system of claim 1, wherein the second cutting unit comprises:
a second mount on which the sub-substrates are placed; and
a second cutting portion cutting one sides of the sub-substrates on the second mount in the second direction.

9. The cutting system of claim 8, wherein the carrier unit comprises a rotator sucking and rotating the sub-substrates whose one sides have been cut to reverse the sub-substrates, and the second cutting unit further comprises a second suction portion sucking and lifting other sides of the sub-substrates from the carrier unit and placing the sub-substrates onto the second mount.

10. The cutting system of claim 9, wherein the second cutting portion cuts in the second direction the other sides of the sub-substrates that have been reversed by the carrier unit and the second suction portion.

11. The cutting system of claim 8, wherein the second cutting portion comprises at least one among a laser and a wheel having a higher hardness than the LCD substrate.

12. A cutting method for a liquid crystal display (LCD) substrate, comprising:
dividing the LCD substrate into a plurality of sub-substrates each comprising at least one panel by cutting the LCD substrate in a first direction;
simultaneously carrying the sub-substrates; and
dividing the sub-substrates into a plurality of panels by simultaneously cutting the sub-substrates in a second direction.

13. The cutting method of claim 12, wherein the dividing of the LCD substrate into the plurality of sub-substrates comprises:
cutting one side of the LCD substrate placed on a first mount in the first direction;
sucking and rotating the LCD substrate, thereby reversing the LCD substrate;
sucking other side of the LCD substrate and placing the LCD substrate on the first mount; and
cutting the other side of the LCD substrate in the first direction.

14. The cutting method of claim 12, wherein the simultaneously carrying of the sub-substrates comprises:
sucking the sub-substrates; and
separating the sub-substrates from each other.

15. The cutting method of claim 12, wherein the dividing of the sub-substrates into the plurality of panels comprises:
cutting in the second direction one sides of the sub-substrates placed on a second mount;
sucking and rotating the sub-substrates whose one sides have been cut, thereby reversing the sub-substrates;
sucking other sides of the sub-substrates and placing the sub-substrates onto the second mount; and
cutting the other sides of the sub-substrates in the second direction.
